(19) United States
(12) Patent Application Publication
(10) Pub. No.: US 2015/0059148 A1
(43) Pub. Date: Mar. 5, 2015

(54) METHOD FOR PRODUCING LIQUID STORAGE CONTAINER

(71) Applicant: CANON KABUSHIKI KAISHA, Tokyo (JP)

(72) Inventors: Masatoshi Ohira, Fujisawa-shi (JP); Hirotaka Miyazaki, Yokohama-shi (JP); Toshiaki Kaneko, Tokyo (JP); Satoshi Shimazu, Kawasaki-shi (JP); Hiroyuki Yamamoto, Kawasaki-shi (JP)

(21) Appl. No.: 14/467,129

(22) Filed: Aug. 25, 2014

(30) Foreign Application Priority Data
Aug. 29, 2013 (JP) 2013-178181

(51) Int. Cl. B41J 2/175

(52) U.S. Cl. CPC B41J 2/17559
USPC 29/428

(57) ABSTRACT

In a case where a liquid holding member is inserted into a storage section to produce a liquid storage container, the occurrence of a wrinkle or a partial separation in the liquid holding member can be suppressed. More specifically, a plurality of compressing needles are stuck into an ink holding member before insertion and moved in directions shown by arrows to compress the ink holding member. The ink holding member in a compressed state is inserted without coming into contact with a wall surface of an ink storage section. This can prevent the ink holding member from coming into contact with an inner wall of the storage container or the like during the insertion of the ink holding member into the storage container and can prevent the occurrence of a wrinkle or a partial separation in the ink holding member.

### BACKGROUND OF THE INVENTION

1. Field of the Invention

The present invention relates to a method for producing a liquid storage container, and particularly relates to a method for putting, in a storage container, a liquid holding member for holding liquid such as an ink.

2. Description of the Related Art

As one form of a liquid storage container, an ink tank used in the field of ink jet printing is known. As this ink tank, there is an ink tank in which an ink holding member made of fiber aggregate, a porous body, or the like is impregnated with and holds an ink, as a feature for ensuring a high capability of supplying an ink to a print head without causing ink leakage.

The liquid holding member which is impregnated with and holds liquid is generally formed in a larger size than a liquid storage section of the liquid storage container, and compressed when the liquid holding member is put into the storage section. Japanese Patent Laid-Open No. H07-125233(1995) discloses a mechanism for compressing and putting the ink holding member into the ink storage section. More specifically, a compressing jig for compressing the ink holding member is also used as a guide jig for inserting the ink holding member into the storage section, and accordingly, it is possible to omit the step of moving the ink holding member from the compressing jig to the guide jig. As a result, it is possible to prevent the deformation of the holding member such as a wrinkle or a partial separation which may occur as the ink holding member moves. In a case where the wrinkle occurs, an ink may trickle down the wrinkle to cause ink leakage. Further, in a case where the partial separation occurs, the partial separation portion may cause the density of the holding member to increase locally.

### SUMMARY OF THE INVENTION

In a first aspect of the present invention, there is provided a method for producing a liquid storage container comprising the steps of: sticking a plurality of compressing members into a liquid holding member for holding liquid; compressing the liquid holding member by moving the plurality of compressing members; and putting the compressed liquid holding member into a storage section of the liquid storage container and drawing the compressing members.

Further features of the present invention will become apparent from the following description of exemplary embodiments (with reference to the attached drawings).

### BRIEF DESCRIPTION OF THE DRAWINGS

FIGS. 1A to 1C are views for explaining an inkjet cartridge according to an embodiment of a liquid storage container of the present invention;

FIGS. 2A to 2C are views for explaining a method for putting an ink holding member in an ink storage section according to a first embodiment of the present invention;

FIGS. 3A and 3B are diagrams for explaining a method for compressing an ink holding member of another form according to the first embodiment;

FIGS. 4A and 4B are views for explaining a method for compressing an ink holding member of another form according to the first embodiment;

FIGS. 5A to 5E are views for explaining the step of putting the ink holding member in an ink storage container according to the first embodiment of the present invention; and

FIGS. 6A and 6B are views for explaining the step of compressing an ink holding member according to a second embodiment of the present invention.

### DESCRIPTION OF THE EMBODIMENTS

In the mechanism disclosed in Japanese Patent Laid-Open No. H07-125233(1995), the liquid holding member is put by using the guide jig, and therefore the guide jig itself may cause a wrinkle or a partial separation of the holding member.

More specifically, in the case of using the guide jig, it is necessary to compress the holding member into a size which is determined in consideration of the thickness of the guide jig to be inserted as well as the size of the ink storage section. In other words, it is necessary to compress the holding member more for the thickness of the guide jig, and this relatively excessive compression may cause a wrinkle. Further, after the guide jig is inserted into the ink storage section, in either the step of drawing the guide jig from the storage section or the step of pressing and inserting the ink holding member into the storage section, the ink holding member may come into contact with the guide jig to cause a partial separation portion on the surface of the ink holding member.

An object of the present invention is to provide a method of producing a liquid storage container capable of suppressing the occurrence of a wrinkle or a partial separation in a liquid holding member when the liquid holding member is put in a storage section.

Embodiments of the present invention will be described below in detail with reference to the drawings.

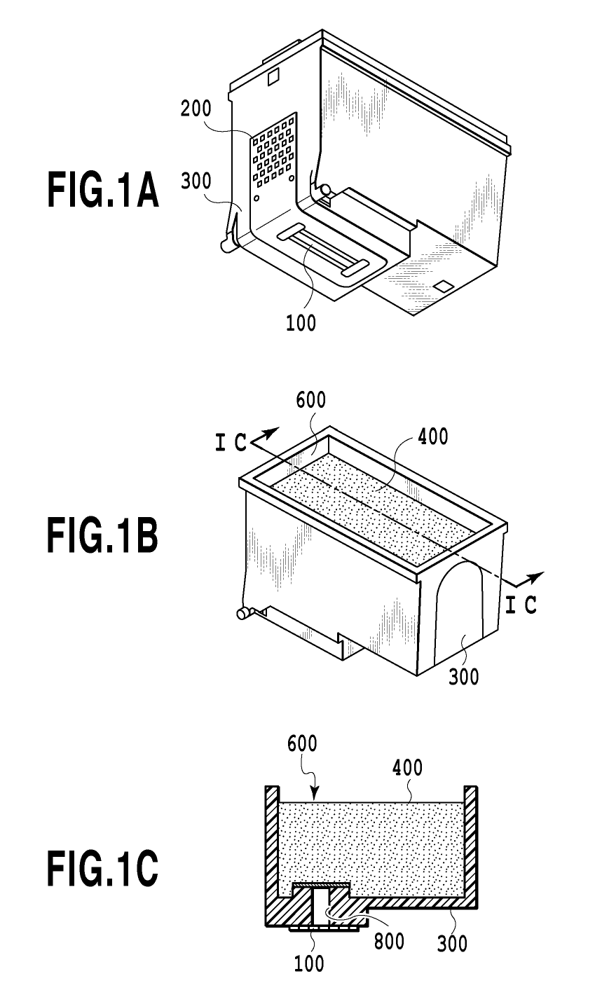

FIGS. 1A to 1C are views for explaining an inkjet cartridge according to an embodiment of a liquid storage container of the present invention. In the inkjet cartridge of the present embodiment, a print head for ejecting an ink and an ink tank (an ink storage container) for storing an ink to be supplied to the print head are integral with each other. As shown in FIG. 1A, the cartridge mainly comprises a printing element substrate 100, an electric wiring board 200, and a support member 300. The printing element substrate 100, the electric wiring board 200, and part of the support member 300 constitute the print head, and the most part of the support member 300 constitutes the ink tank.

The printing element substrate 100 constituting the print head comprises an array of a plurality of ejection openings and electrothermal conversion elements corresponding to the ejection openings, and ejects an ink from the corresponding ejection openings by using thermal energy generated by the electrothermal conversion elements. The electric wiring board 200 connects an electric signal between the cartridge of the present embodiment and a printing apparatus in which the cartridge is mounted, whereby the printing element substrate 100 can receive a control signal and print data for ejecting an ink from a control section of the printing apparatus.

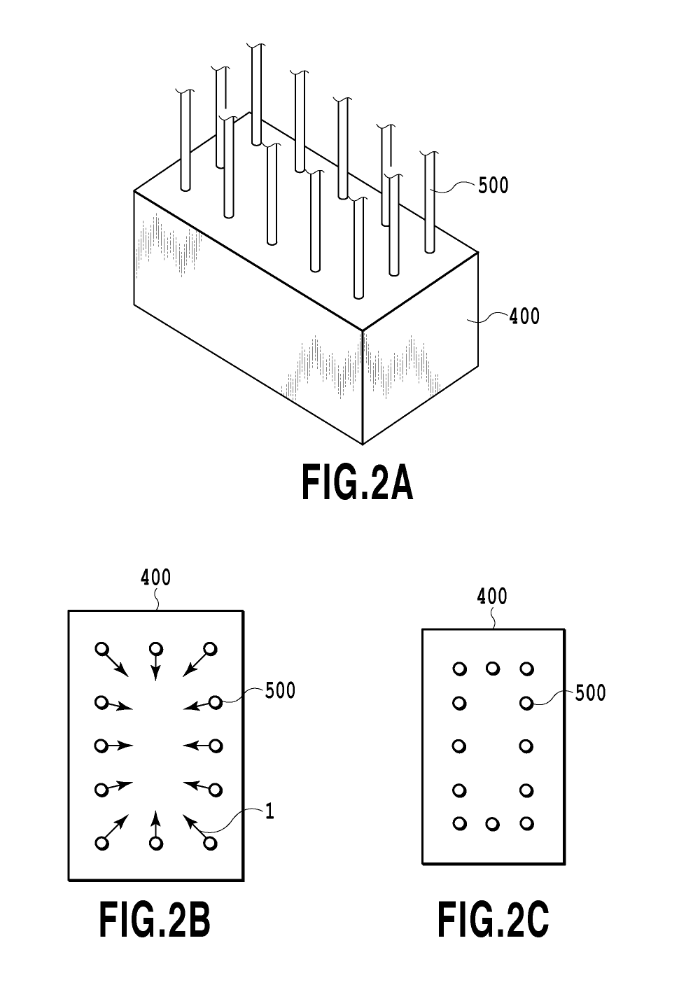

The support member 300 forms an ink storage section 600 containing an ink holding member 400 (a liquid holding member) and storing an ink held by the ink holding member 400 as shown in FIG. 1B and FIG. 1C showing an IC-IC line cross-section of FIG. 1B. The ink holding member 400 is put and compressed into the ink storage section 600 to hold an ink by its capillary force. In this manner, the ink holding member 400 generates apparent negative pressure with respect to the ejection openings of the printing element substrate 100 and the air. The ink holding member 400 is formed in a larger size than the ink storage section 600. As described later with reference to FIG. 2 and the like, the ink holding member 400 is compressed to a size smaller than that of the ink storage section 600 and inserted and fixed in the storage section by its restoring force.

The ink holding member can be mainly formed of fiber aggregate of polypropylene or the like, polyurethane foam, or the like. In the present embodiment, the fiber aggregate is used. Further, the fiber aggregate of the present embodiment is formed by laminating and thermally treating fiber made of a polypropylene core coated with polyethylene to melt polyethylene and bond the crossing points of the fiber.

### First Embodiment

A first embodiment of the present invention relates to a method of putting the ink holding member in the ink storage section. FIGS. 2A to 2C are views for explaining the method of putting the ink holding member in the ink storage section.

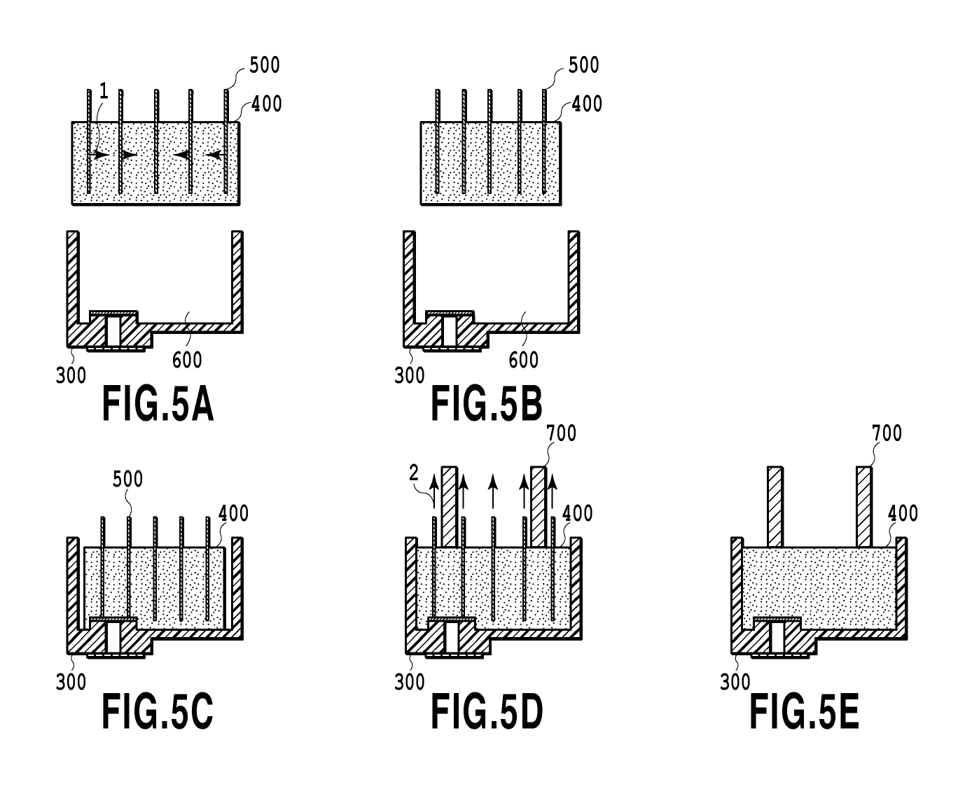

In this method, a plurality of compressing needles 500 are firstly stuck into the ink holding member 400 to be put in the ink storage section, as shown in FIG. 2A. Next, as shown in FIG. 2B, the stuck compressing needles 500 are moved in directions toward the inside of the ink holding member 400 shown by arrows 1. This causes the ink holding member 400 as a whole to be in a compressed state as shown in FIG. 2C. While this compressed state is maintained, the ink holding member 400 is inserted into the ink storage section 600 as described later with reference to FIG. 5.

In a case where the compressing needles are moved with excessively large distances between the compressing needles, a wrinkle may occur between the needles in the holding member. Therefore, it is desirable to stick many compressing needles so that the distances between the compressing needles become small. However, in a case where many needles are stuck to the extent that the needles are in contact with each other, there is a possibility that the ink holding member may be torn during compression and movement. Accordingly, it is desirable to determine the number of stuck compressing needles in consideration of the characteristics of the employed ink holding member. In the present embodiment, compressing needles having an outer diameter of 1.2 mm are stuck at intervals of 5 mm. This can realize compression without wrinkles.

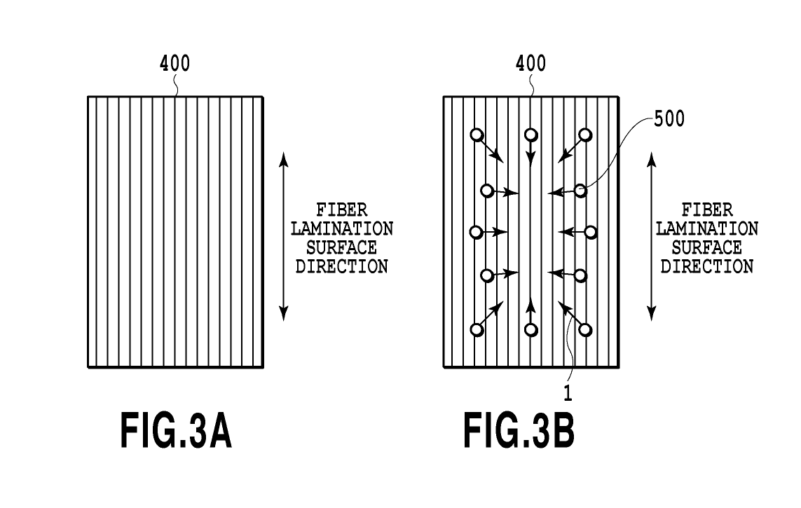

In a type of the ink holding member which is formed by laminating fiber as shown in FIG. 3A, interlayer peeling may occur in a case where a plurality of compressing needles are stuck into the same fiber lamination surface and moved for compression. In this case, interlayer peeling during compression and movement can be prevented by arranging the compressing needles in a zigzag pattern, for example so that adjacent compressing needles are not stuck into the same layer or lamination surface as shown in FIG. 3B. It should be noted that in the case of an ink holding member of a foam type such as polyurethane foam, such peeling does not occur.

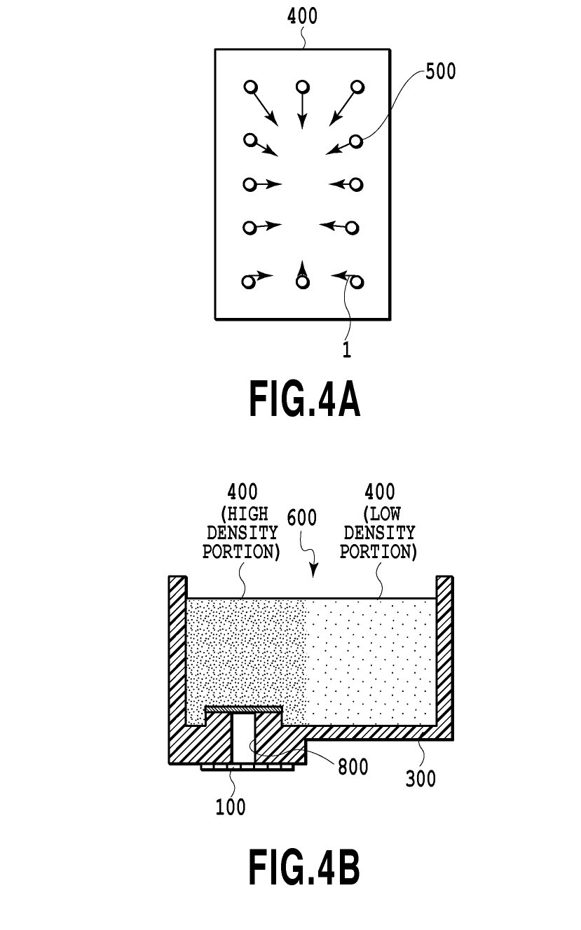

Further, as shown in FIGS. 4A and 4B, the ink holding member after compression may be intentionally provided with a coarse and fine distribution by setting the moving distance of a compressing needle according to the position of the needle. For example, the density can be increased by increasing the moving distance for compression of a portion of the ink holding member 400 around an ink path 800 of the printing element substrate. This makes it possible to efficiently concentrate an ink injected into the holding member near the ink flow path 800 and to increase ink supply efficiency. Incidentally, the shape of the ink holding member before insertion into the ink storage section is not uniform for the arrangement of the compressing needles so that the ink holding member has the above density distribution. This shape is not clearly shown in FIG. 4A, but a portion having a high density after insertion has a large volume before insertion. In this manner, a portion having a larger volume is moved a larger distance, whereby in a case where the ink holding member after insertion into the storage section is free from compression by the needles and conforms to the shape of the storage section, the ink holding member does not have a uniform density distribution similar to the one before insertion and can have a desired density distribution.

Next, FIGS. 5A to 5E are sectional views for explaining the step of putting the ink holding member in the ink storage container, according to the present embodiment.

Firstly, as shown in FIG. 5A, the plurality of compressing needles 500 are stuck into the ink holding member 400 before insertion and moved in the directions shown by the arrows 1 in FIG. 5A (FIG. 2B or FIG. 4A) to compress the ink holding member 400. Next, as shown in FIG. 5B, the compressed ink holding member 400 is set above the ink storage section 600 of the ink storage container. Then, as shown in FIG. 5C, the ink holding member 400 is inserted in a compressed state without coming into contact with a wall surface of the ink storage section 600. In other words, the needles compress the holding member to a size such that the compressed holding member is not in contact with the wall surface of the ink storage section. This can prevent the ink holding member from coming into contact with an inner wall of the storage container or the like during the insertion of the ink holding member into the storage container and can prevent the occurrence of a wrinkle or a partial separation in the ink holding member.

Next, as shown in FIG. 5D, forces applied to the compressing needles 500 in the moving directions are released. This causes the ink holding member 400 to conform to the inner wall of the ink storage section 600. Further, as shown in FIG. 5D, while a pressing member 700 presses an upper surface of the ink holding member, the compressing needles 500 are drawn in a direction shown by an arrow 2 in FIG. 5D to complete the insertion of the ink holding member (FIG. 5E). Thereafter the pressing member 700 is removed and a container cover is attached to complete the ink tank.

A producing apparatus can perform the above-described method for producing the ink tank. In this method, a holder is prepared which holds the plurality of needles 500 and which can move the held needles independently. The holder is driven to stick, to a predetermined depth, the plurality of needles having positional relationships shown in FIG. 2A into the ink holding member 400 set in a predetermined position. Next, the holder is driven to move the compressing needles as shown in FIG. 2B or FIG. 4A. Further, the ink holding member 400 held and compressed by the holder is aligned with the ink storage section 600 of the storage container held by another holder, and is moved and put into the storage section. Thereafter, while a holder holding the pressing member 700 is driven to cause the pressing member 700 to press the ink holding member 400 as shown in FIG. 5D, the needle holder is driven to draw the compressing needles 500 from the ink holding member. Further, the holder holding the pressing member is driven to remove the pressing member 700 from the ink holding member.

### Second Embodiment

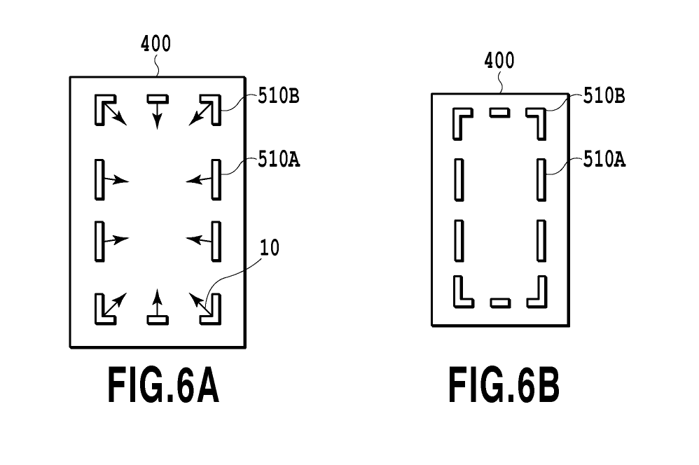

A second embodiment of the present invention relates to an embodiment using compressing claws in place of the compressing needles of the above-described first embodiment. FIGS. 6A and 6B are views for explaining the step of compressing an ink holding member according to this embodiment.

As shown in FIG. 6A, as compressing claws 510, there are two types of claws, that is, claws 510A which are rectangular in cross section and claws 510B which are hooked in cross section. These claws 510A and 510B are inserted (stuck) into the ink holding member 400 like the compressing needles 500 of the first embodiment. The claws 510A and 510B are moved in directions shown by arrows 10 in FIG. 6A to compress the ink holding member 400 as shown in FIG. 6B. It is desirable that the claws as the compressing members be as thin in cross section as possible as long as their rigidity reaches a desired value. This is intended to reduce, as much as possible, the effects of performing cutting by sticking the claws into the ink holding member.

In the present embodiment, the rigidity of the compressing members can be increased by forming the compressing members to be inserted into the ink holding member to be rectangular or hooked in cross section. This makes it possible to avoid a state in which movement of the compressing members is attempted for compression but the compressing members cannot be moved for sufficient compression against the resistance of the holding member depending on the properties of the ink holding member to be put into the ink storage section.

Also in the case of using the compressing claws of the present embodiment, it is necessary to be careful of the occurrence of a wrinkle during compression and movement. As a result of verification, it is found that an excellent compressed state without wrinkles can be achieved by using the compressing claws having widths in each side of the ink holding member, the sum of which is equal to or larger than half of the length of the side of the ink holding member. In specific explanation with an example shown in FIG. 6A, the ink holding member has four sides. The compressing claws are used along each of the four sides. Let the length of one of the four sides of the ink holding member be X. The sum of lengths of the compressing claws along the one side (the sum of the lengths of the four compressing claws in a case of a right side) is equal to or larger than X/2.

Incidentally, it is not necessary that all the compressing members be either the needles or the claws. It is possible to use the needles and the paws in combination.

### OTHER EMBODIMENTS

The above-described embodiments relate to a method for producing a container for storing an ink. However, it is natural that application of the present invention is not limited to these embodiments. The present invention can be applied to any type of liquid storage container as long as a liquid holding member can be put into the liquid storage container.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-178181 filed Aug. 29, 2013, which is hereby incorporated by reference herein in its entirety.

What is claimed is:

1. A method for producing a liquid storage container comprising the steps of:
sticking a plurality of compressing members into a liquid holding member for holding liquid;
compressing the liquid holding member by moving the plurality of compressing members; and
putting the compressed liquid holding member into a storage section of the liquid storage container and drawing the compressing members.

2. The method according to claim 1, wherein the compressing members are needles.

3. The method according to claim 1, wherein the liquid holding member is formed by laminating fiber, and the plurality of compressing members are stuck into the liquid holding member in a zigzag pattern relative to a direction of a fiber lamination surface.

4. The method according to claim 1, wherein the compressing members are claws which are rectangular in cross section.

5. The method according to claim 1, wherein a moving distance of each of the plurality of compressing members in the compressing step is set so that the compressed liquid holding member has a coarse and fine distribution.

6. The method according to claim 1, wherein the compressing members have claws which are hooked in cross section.

7. The method according to claim 1, wherein the compressing members have claws which are rectangular and hooked in cross section.
